(19) United States
(12) Patent Application Publication
(10) Pub. No.: US 2013/0189505 A1
(43) Pub. Date: Jul. 25, 2013

(54) MOUNTING MAT AND EXHAUST GAS TREATMENT DEVICE

(71) Applicant: Unifrax I LLC, Niagara Falls, NY (US)

(72) Inventor: Amit Kumar, Getzville, NY (US)

(73) Assignee: UNIFRAX I LLC, Niagara Falls, NY (US)

(21) Appl. No.: 13/744,998

(22) Filed: Jan. 18, 2013

Related U.S. Application Data
(60) Provisional application No. 61/589,424, filed on Jan. 23, 2012.

(51) Int. Cl. B32B 7/02; B32B 5/26

(52) U.S. Cl. CPC B32B 7/02; B32B 5/26
USPC 428/212; 422/168; 428/221

(57) ABSTRACT

A mounting mat for an exhaust gas treatment device includes a mounting mat of inorganic fibers having a first major surface and a second major surface opposite the first major surface, wherein the first major surface has an elongation different from that of the second major surface. An exhaust gas treatment device including the mounting mat and methods for making the mounting mat and the exhaust gas treatment device are also provided.

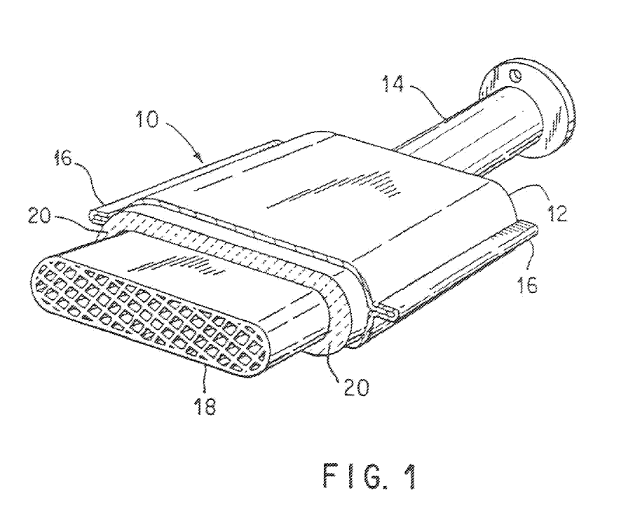

### CROSS REFERENCE TO RELATED APPLICATIONS

This application claims the benefit of the filing date under 35 U.S.C. 119(e) from Provisional Application For Patent Ser. No. 61/589,424 filed Jan. 23, 2012, which is hereby incorporated by reference.

A device for the treatment of exhaust gases, such as a catalytic converter or a diesel particulate trap is provided. The exhaust gas treatment device includes a fragile structure mounted within a housing by a mounting mat that is disposed in a gap between the housing and the fragile structure.

Exhaust gas treatment devices are used on automobiles to reduce atmospheric pollution generated by engine emissions. Examples of widely used exhaust gas treatment devices include catalytic converters and diesel particulate traps.

A catalytic converter for treating exhaust gases of an automotive engine includes a housing, a fragile catalyst support structure for holding the catalyst that is used to effect the oxidation of carbon monoxide and hydrocarbons and the reduction of oxides of nitrogen, and a mounting mat disposed between the outer surface of the fragile catalyst support structure and the inner surface of the housing to resiliently hold the fragile catalyst support structure within the housing.

A diesel particulate trap for controlling pollution generated by diesel engines generally includes a housing, a fragile particulate filter or trap for collecting particulate from the diesel engine emissions, and a mounting mat that is disposed between the outer surface of the filter or trap and the inner surface of the housing to resiliently hold the fragile filter or trap structure within the housing.

The fragile structure generally comprises a monolithic structure manufactured from a frangible material of metal or a brittle, ceramic material such as aluminum oxide, silicon dioxide, magnesium oxide, zirconia, cordierite, silicon carbide and the like. These materials provide a skeleton type of structure with a plurality of gas flow channels. These monolithic structures can be so fragile that even small shock loads or stresses are often sufficient to crack or crush them. In order to protect the fragile structure from thermal and mechanical shock and other stresses noted above, as well as to provide thermal insulation and a gas seal, a mounting mat is positioned within the gap between the fragile structure and the housing.

The mounting mat materials employed should be capable of satisfying any of a number of design or physical requirements set forth by the fragile structure manufacturers or the exhaust gas treatment device manufacturers. For example, the mounting mat material should be capable of exerting an effective residual holding pressure on the fragile structure, even when the exhaust gas treatment device has undergone wide temperature fluctuations, which causes significant expansion and contraction of the metal housing in relation to the fragile structure, which in turn causes significant compression and release cycles for the mounting mats over a period of time.

The mounting mat must function across a wide range of operating temperatures to effectively hold the substrate in position. Substrates are subjected to axial forces acting on the substrate due to vibrations. The mounting mat also compensates for the fact that the metal housing expands more or less than the substrate itself. Various exhaust gas treatment devices operate throughout a temperature range of ambient conditions 20° C. to about 1200° C.

Mounting mats vary in size and thickness based on the design of the exhaust gas treatment device and the desired properties of the mounting mat. In some cases, thicker mounting mats are used to support the ceramic or metallic substrates used in the exhaust gas treatment device. It is often difficult to wrap these thicker mounting mats around the substrates. This is because the circumference and diameter of the substrate may be significantly smaller than the circumference and diameter of the inner surface of the mounting mat when wrapped around the substrate and because the circumference and diameter of the inner surface of the housing of the exhaust gas treatment device may be significantly larger than the outer surface of the mounting mat when wrapped around the substrate.

In order to accommodate the differences in size between the inner surface of the mounting mat and the outer surface of the mounting mat, the outer surface of the substrate and the inner surface of the housing, a compromise is often made in the length of the mounting mat so that the mounting mat is neither too long on the inside nor too short on the outside when it is wrapped around the substrate within the housing. This compromise in the length of the mounting mat often results in a gap between the outer surface of the substrate and the inner surface of the mounting mat and between the inner surface of the housing and the outer surface of the mounting mat.

What is needed in the industry is a flexible mounting mat for exhaust gas treatment devices, wherein the mounting mat has an inner surface circumference and diameter which more closely matches the outer surface circumference and diameter of the substrate and wherein the mounting mat has an outer surface circumference and diameter which more closely matches the circumference and diameter of the inner surface of the housing of the exhaust gas treatment device.

Provided is a mounting mat for an exhaust gas treatment device comprising a sheet of inorganic fibers having a first major surface and a second major surface opposite the first major surface, wherein the first major surface has an elongation different from that of the second major surface.

Also provided is an exhaust gas treatment device comprising a housing, a fragile structure resiliently mounted within the housing, and a mounting mat disposed in a gap between the housing and the fragile structure, wherein the mounting mat comprises a sheet of inorganic fibers having a first major surface and a second major surface opposite said first major surface, wherein the first major surface has an elongation different from that of the second major surface.

Additionally provided is a method of making an exhaust gas treatment device, comprising wrapping a mounting mat comprising a sheet of inorganic fibers having a first major surface and a second major surface opposite said first major surface, wherein the first major surface has an elongation different from that of the second major surface, around at least a portion of a fragile substrate and positioning the wrapped fragile structure within an outer housing.

The mounting mat for an exhaust gas treatment device comprises a layer or sheet of high temperature resistant inorganic fibers. The mounting mat has a first major surface and a second major surface. The first and second major surfaces of the mounting mat have different elongations which allow the mounting mat to elongate or otherwise stretch to different lengths upon application of the same load to the mounting mat. The ability of the inner and outer surfaces of the mounting mat to stretch to different lengths does not affect the flexibility of the mounting mat, nor does it affect the ability of the mounting mat to be wrapped around the substrate without cracking.

The sheet of inorganic fibers which make up the mounting mat may comprise at least one layer of inorganic fibers. According to certain embodiments, the mounting mat for the exhaust gas treatment device comprises a single layer. According to other certain embodiments, the mounting mat for the exhaust gas treatment device comprises multiple layers of inorganic fibers that are joined together to form a mounting mat of inorganic fibers. According to certain embodiments, two layers of inorganic fibers are joined together to form the mounting mat of inorganic fibers. The at least two layers of inorganic fibers may have the same or different fiber compositions.

The mounting mat is fabricated such that when a tensile load is applied to both the first and second major surfaces of the mounting mat, the first major surface of the mounting mat stretches or elongates to a first length and the second major surface stretches or elongates to a second length that is different from the first length.

The first and second major surfaces of the mounting mat are capable of stretching or elongating to different lengths event when the tensile load applied to the first and second major surfaces of the mounting mat is the same or substantially the same. According to certain embodiments, the first major surface of the mounting mat is capable of stretching to a length greater than the second major surface of the mounting mat upon application of the same tensile load to the first and second major surfaces without cracking the mounting mat.

According to certain embodiments, the first major surface of the mounting mat corresponds to the inner surface of the mounting mat while the second major surface of the mounting mat corresponds to the outer surface of the mounting mat. The inner surface of the mounting mat when assembled within an exhaust gas treatment device is in contact with or at least in close proximity to the outer surface of the fragile substrate. The outer surface of the mounting mat when assembled within an exhaust gas treatment device is in contact with or at least in close proximity to the inner surface of the housing of the exhaust gas treatment device. According to certain embodiments, the outer surface of the mounting mat is capable of elongating or otherwise stretching to a length that is greater than the inner surface of the mounting mat upon application of the same tensile load to the outer and inner surface without cracking the mounting mat.

The different elongations of different portions of the mounting mat may be achieved by using different types of binder materials in different portions of the mounting mat. For example, and without limitation, a first type of binder material may be used in a certain portion of the mounting mat to achieve a certain elongation and a second different type of binder material may be used in another portion of the mounting mat that achieves an elongation that is different from the elongation achieved in the other portion of the mounting mat.

According to other embodiments, the different elongations of different portions of the mounting mat may be achieved by using different amounts of binder materials in different portions of the mounting mat. For example, and without limitation, a first amount of binder material may be used in a certain portion of the mounting mat to achieve a certain elongation and a second different amount of binder material may be used in another portion of the mounting mat that achieves an elongation that is different from the elongation achieved in the other portion of the mounting mat having the first amount of binder material.

The different elongations of different portions of the mounting mat may be achieved by using different types of fibers in different portions of the mounting mat. For example, and without limitation, a first type of fiber may be used in a certain portion of the mounting mat to achieve a certain elongation and a second different type of fiber may be used in another portion of the mounting mat that achieves an elongation that is different from the elongation achieved in the other portion of the mounting mat.

The different elongations of different portions of the mounting mat may be achieved by using different lengths of fibers in different portions of the mounting mat. For example, and without limitation, a first length of fiber may be used in a certain portion of the mounting mat to achieve a certain elongation and a second different length of fiber may be used in another portion of the mounting mat that achieves an elongation that is different from the elongation achieved in the other portion of the mounting mat.

Any heat resistant inorganic fibers may be utilized in the mounting mat so long as the fibers can withstand the mounting mat forming process, can withstand the operating temperatures of the exhaust gas treatment device, and provide the minimum holding pressure performance for holding fragile structure within the exhaust gas treatment device housing at the operating temperatures. Without limitation, suitable inorganic fibers that may be used to prepare the mounting mat and exhaust gas treatment device include high alumina polycrystalline fibers, refractory ceramic fibers such as alumino-silicate fibers, alumina-magnesia-silica fibers, mullite fibers, kaolin fibers, alkaline earth silicate fibers such as calcia-magnesia-silica fibers and magnesia-silica fibers, glass fibers such as S-glass fibers, S2-glass fibers, and E-glass fibers, quartz fibers, silica fibers and combinations thereof.

According to certain embodiments, the heat resistant inorganic fibers that are used to prepare the mounting mat comprise ceramic fibers. Without limitation, suitable ceramic fibers include alumina fibers, alumina-silica fibers, alumina-zirconia-silica fibers, zirconia-silica fibers, zirconia fibers and similar fibers. A useful alumina-silica ceramic fiber is commercially available from Unifrax I LLC (Niagara Falls, N.Y.) under the registered trademark FIBERFRAX. The FIBERFRAX ceramic fibers comprise the fiberization product of about 45 to about 75 weight percent alumina and about 25 to about 55 weight percent silica. The FIBERFRAX fibers exhibit operating temperatures of up to about 1540° C. and a melting point up to about 1870° C. The FIBERFRAX fibers easily formed into high temperature resistant sheets and papers.

According to certain embodiments, the alumina/silica fiber may comprise from about 40 weight percent to about 60 weight percent Al₂O₃ and about 60 weight percent to about 40 weight percent SiO₂. The fiber may comprise about 50 weight percent Al₂O₃ and about 50 weight percent SiO₂. The alumina/silica/magnesia glass fiber typically comprises from about 64 weight percent to about 66 weight percent SiO₂, from about 24 weight percent to about 25 weight percent Al₂O₃, and from about 9 weight percent to about 10 weight percent MgO. The E-glass fiber typically comprises from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

Without limitation, suitable examples of biosoluble alkaline earth silicate fibers that can be used to prepare a mounting mat for an exhaust gas treatment device include those fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,075, 5,821,183, and 5,811,360, which are incorporated herein by reference.

According to certain embodiments, the biosoluble alkaline earth silicate fibers may comprise the fiberization product of a mixture of oxides of magnesium and silica. These fibers are commonly referred to as magnesium-silicate fibers. The magnesium-silicate fibers generally comprise the fiberization product of about 60 to about 90 weight percent silica, from greater than 0 to about 35 weight percent magnesia and 5 weight percent or less impurities. According to certain embodiments, the heat treated alkaline earth silicate fibers comprise the fiberization product of about 65 to about 86 weight percent silica, about 14 to about 35 weight percent magnesia and 5 weight percent or less impurities. According to other embodiments, the heat treated alkaline earth silicate fibers comprise the fiberization product of about 70 to about 86 weight percent silica, about 14 to about 30 weight percent magnesia, and 5 weight percent or less impurities. A suitable magnesium-silicate fiber is commercially available from Unifrax I LLC (Niagara Falls, N.Y.) under the registered trademark ISOFRAX. Commercially available ISOFRAX fibers generally comprise the fiberization product of about 70 to about 80 weight percent silica, about 18 to about 27 weight percent magnesia and 4 weight percent or less impurities.

According to certain embodiments, the biosoluble alkaline earth silicate fibers may comprise the fiberization product of a mixture of oxides of calcium, magnesium and silica. These fibers are commonly referred to as calcia-magnesia-silica fibers. According to certain embodiments, the calcia-magnesia-silicate fibers comprise the fiberization product of about 45 to about 90 weight percent silica, from greater than 0 to about 45 weight percent calcia, from greater than 0 to about 35 weight percent magnesia, and 10 weight percent or less impurities. Useful calcia-magnesia-silicate fibers are commercially available from Unifrax I LLC (Niagara Falls, N.Y.) under the registered trademark INSULFRAX. INSULFRAX fibers generally comprise the fiberization product of about 61 to about 67 weight percent silica, from about 27 to about 33 weight percent calcia, and from about 2 to about 7 weight percent magnesia. Other suitable calcia-magnesia-silicate fibers are commercially available from Thermal Ceramics (Augusta, Ga.) under the trade designations SUPERWOOL 607, SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprises about 74 weight percent silica, about 24 weight percent calcia and trace amounts of magnesia, alumina and iron oxide.

Suitable silica fibers use in the production of a mounting mat for an exhaust gas treatment device include those leached glass fibers available from BelChem Fiber Materials GmbH, Germany, under the trademark BELCOTEX, from Hitco Carbon Composites, Inc. of Gardena Calif., under the registered trademark REFRASIL, and from Polotsk-Steklovolokno, Republic of Belarus, under the designation PS-23(R).

The BELCOTEX fibers are standard type, staple fiber pre-yarns. These fibers have an average fineness of about 550 tex and are generally made from silicic acid modified by alumina. The BELCOTEX fibers are amorphous and generally contain about 94.5 silica, about 4.5 percent alumina, less than 0.5 percent sodium oxide, and less than 0.5 percent of other components. These fibers have an average fiber diameter of about 9 microns and a melting point in the range of 1500° to 1550° C. These fibers are heat resistant to temperatures of up to 1100° C., and are typically shot free and binder free.

The REFRASIL fibers, like the BELCOTEX fibers, are amorphous leached glass fibers high in silica content for providing thermal insulation for applications in the 1000° to 1100° C. temperature range. These fibers are between about 6 and about 13 microns in diameter, and have a melting point of about 1700° C. The fibers, after leaching, typically have a silica content of about 95 percent by weight. Alumina may be present in an amount of about 4 percent by weight with other components being present in an amount of 1 percent or less.

The PS-23 (R) fibers from Polotsk-Steklovolokno are amorphous glass fibers high in silica content and are suitable for thermal insulation for applications requiring resistance to at least about 1000° C. These fibers have a fiber length in the range of about 5 to about 20 mm and a fiber diameter of about 9 microns. These fibers, like the REFRASIL fibers, have a melting point of about 1700° C.

The intumescent material that may be incorporated into the mounting mat includes, without limitation, unexpanded vermiculite, ion-exchanged vermiculite, heat treated vermiculite, expandable graphite, hydrobiotite, water-swelling tetrasilicic flourine mica, alkaline metal silicates, or mixtures thereof. The mounting mat may include a mixture of more than on type of intumescent material. The intumescent material may comprise a mixture of unexpanded vermiculite and expandable graphite in a relative amount of about 9:1 to about 1:2 vermiculite:graphite, as described in U.S. Pat. No. 5,384,188.

As described above, flexibility, elongation differences within the mounting mat, and crack resistance of the mounting mat may be achieved by impregnating the mounting mat with various types of organic binders, varying the amount and/or type of inorganic fiber impregnated within different portions of the mounting mat and/or by varying the length of inorganic fiber within the mounting mat. According to certain embodiments, the type and/or amount of binder and/or the length of the inorganic fiber utilized on the outer surface of the mounting mat vary from the amount and/or type of binder and/or the length of the inorganic fiber utilized on the inner surface of the mounting mat.

In certain embodiments, the type of binder utilized on the outer surface of the mounting mat varies from the type of binder utilized on the inner surface of the mounting mat. In other embodiments, the amount of binder utilized on the outer surface of the mounting mat varies from the amount of binder utilized on the inner surface of the mounting mat. In other embodiments, the amount of binder and the type of binder utilized on the outer surface of the mounting mat varies from the amount of binder and the type of binder utilized on the inner surface of the mounting mat.

In certain embodiments, the length of fibers utilized on the outer surface of the mounting mat varies from the length of fibers utilized on the inner surface of the mounting mat. In other embodiments, the amount of binder and length of fibers utilized on the outer surface of the mounting mat varies from the amount of binder and length of fibers utilized on the inner surface of the mounting mat. In other embodiments, the type of binder and length of fibers utilized on the outer surface of the mounting mat varies from the type of binder and length of fibers utilized on the inner surface of the mounting mat. In other embodiments, the amount and type of binder and length of fibers utilized on the outer surface of the mounting mat varies from the amount and type of binder and length of fibers utilized on the inner surface of the mounting mat.

In certain embodiments, the amount of binder that may be applied on the first major surface of mounting mat may be from about 1 to about 20 percent by weight based on the total weight of the mounting mat and the amount of binder that may be applied on second major surface of the mounting mat may range from about 1 to about 20 percent by weight based on the total weight of the mounting mat.

Without being bound to any particular theory, long fibers tend to give shorter elongation as compared to shorter fibers, as they are more mechanically interweaved. Shorter fibers have lower tensile strength and therefore will elongate more than longer fibers under the same load.

Any binder may be utilized in the mounting mat so long as the binder can adequately hold the fibers together without cracking the mounting mat during the installation process, allows the mounting mat to remain flexible enough to be wrapped around the substrate. In certain embodiments, the mounting mat may comprise a mixture of more than one type of binder. Without limitation, suitable binders that may be used to prepare the mounting mat include organic binders and inorganic binders. In certain embodiments, the mounting mat may comprise a mixture of inorganic and inorganic binders. Organic binders are typically sacrificial in nature. By “sacrificial” it is meant that the binder will eventually be burned out of the mounting mat, leaving only the fibers as the final mounting mat. Suitable binders include aqueous and nonaqueous binders.

In certain embodiments, the organic binder may comprise at least one of a solid, a liquid, or mixtures thereof. Liquid organic binders may comprise an aqueous emulsion. In certain embodiments, the aqueous emulsion may comprise a dispersion of a polymer within a solvent.

In certain embodiments, the aqueous emulsion comprises a latex. The latex may comprise a thermoplastic resin, a thermosetting resin or mixtures of a thermoplastic resin and a thermosetting. The thermoplastic resin or thermosetting resin utilized on the mounting mat may allow the mounting mat to remain flexible after the binder is cured. The thermoplastic resin or thermosetting resin can be burned out of an installed mounting mat.

The thermosetting resin may be a low temperature, flexible thermosetting resin. In certain embodiments, the low temperature, flexible thermosetting resin may comprise at least one of unsaturated polyesters, epoxy resins, polyvinyl esters, or mixtures thereof.

Any latex may be utilized as a component of the binder so long as it can adequately hold the fibers together without cracking the mounting mat during the installation process and allows the mounting mat to remain flexible enough to be wrapped around the substrate. In certain embodiments, the latex may comprise at least one of acrylic latex, (meth)acrylic latex, copolymers of styrene and butadiene, cellulose, a rubber based organic polymer, vinylpyridine, acrylonitrile, copolymers of acrylonitrile and styrene, vinyl chloride, polyurethane, vinyl acetate, copolymers of vinyl acetate and ethylene, polyamides, silicones, butadiene-acrylonitrile lattices, and lattices of acrylate and methacrylate polymers or copolymers, or mixtures thereof.

In certain embodiments, the binder may also comprise an inorganic colloidal material. The inorganic colloidal material may be present alone or in combination with one or more organic binders. In certain embodiments, the inorganic colloidal material may be present within an aqueous emulsion of liquid organic binder. The inorganic colloidal material may comprise at least one of colloidal silica, colloidal alumina, colloidal zirconia, or combinations thereof.

Aqueous inorganic binders may also contain a solvent. Solvents for the binders can include water, or a suitable organic solvent, such as acetone, for the binder utilized.

Alternatively, the organic binder may comprise a solid or liquid organic binder which is a solvent-free polymer. In certain embodiments, the solvent-free polymer which comprises the organic binder can include natural rubber, styrene-butadine rubber, and other elastomers, or mixtures thereof.

In other embodiments, the liquid organic binder may also comprise polymeric binder fibers. Polymeric binder fibers may be used instead of, or in addition to, a resinous or liquid binder. These polymeric binder fibers may be used in amounts ranging from about 1 to about 20 percent by weight, from about 1 to about 10 weight percent, and from about 1 to about 5 weight percent, based upon 100 percent by weight of the total composition, to aid in binding the heat resistant inorganic fibers together. Suitable examples of polymeric binder fibers which may be utilized include polyvinyl alcohol fibers, polyolefin fibers, acrylic fibers, polyester fibers, ethyl vinyl acetate fibers, nylon fibers or mixtures thereof. Examples of polyolefin fibers which may be utilized as binder fibers include polyethylene fibers, polypropylene fibers, or mixtures thereof.

Also provided is an exhaust gas treatment device. The exhaust gas treatment device comprises a housing; a fragile structure resiliently mounted within the housing; and a mounting mat disposed in a gap between the housing and the fragile structure. The mounting mat comprises a sheet of inorganic fibers having a first major surface and a second major surface opposite said first major surface. The first major surface of the mounting mat has an elongation which is different from the elongation of the second major surface. The differences in elongation between the surfaces of the mounting mat allow the first major surface of the mounting mat to stretch to a first length and the second major surface to stretch to a second length upon application of a tensile load.

Further provided is method of making an exhaust gas treatment device. According to the method, a mounting mat of melt-formed inorganic fibers is provided. The mounting mat of melt-formed inorganic fibers comprises a sheet of inorganic fibers having a first major surface and a second major surface opposite the first major surface. The first major surface and the second major surface of the mounting mat can be treated with different amounts and/or types or binder. The first major surface and the second major surface of the mounting mat may also comprise different lengths of inorganic fibers.

The mounting mat is wrapped around a fragile structure adapted for treating exhaust gases. The fragile structure and the mounting mat are then disposed within the housing of the exhaust gas treatment device. The mounting mat is in contact with or in close proximity to the outer surface of the fragile structure and the inner surface of the housing to hold the fragile structure resiliently within the housing. The mounting mat may be characterized as having a first major surface and a second major surface. In certain embodiments, the first major surface comprises the inner surface of the mounting mat which is in contact with or in close proximity to the outer surface of the fragile substrate and the second major surface comprises the outer surface of the mounting mat which is in contact with or in close proximity to the inner surface of the housing. In certain embodiments, the diameter and circumference of the outer surface of the mounting mat is capable of fitting within the inner surface of the housing and the diameter and circumference of the inner surface of the mounting mat is capable of fitting around the outer surface of the fragile structure.

Thus, provided is a mounting mat for an exhaust gas treatment device comprising a sheet of inorganic fibers having a first major surface and a second major surface opposite said first major surface, wherein the first portion of said mat has an elongation different from that of a second portion of said mat.

The mounting mat of the above embodiment wherein the first major surface has an elongation different from that of the second major surface.

The mounting mat of the above embodiments wherein the sheet of inorganic fibers comprises at least one layer of inorganic fibers.

The mounting mat of any one of the above embodiments wherein at least two layers of inorganic fibers are heat pressed together to form the sheet of inorganic fibers.

The mounting mat of any one of the above embodiments wherein the at least two layers of inorganic fibers have the same or different fiber compositions.

The mounting mat of any one of the above embodiments wherein the sheet of inorganic fibers wherein application of a tensile load to the first and second major surfaces stretches the first major surface to a first length and stretches the second major surface to a second length.

The mounting mat of any one of the above embodiments wherein the first major surface of the mounting mat is capable of stretching to a length greater than the second major surface of the mounting mat upon application of the same tensile load to the first and second major surfaces without cracking the mounting mat.

The mounting mat of any one of the above embodiments wherein said first major surface comprises an inner surface of the mounting mat and wherein the second major surface comprises an outer surface of the mounting mat.

The mounting mat of any one of the above embodiments wherein the outer surface of the mounting mat is capable of stretching to a length greater than the inner surface of the mounting mat upon application of the same tensile load to the outer and inner surfaces without cracking the mounting mat.

The mounting mat of any one of the above embodiments wherein the type of binder utilized on the outer surface of the mounting mat varies from the type of binder utilized on the inner surface of the mounting mat.

The mounting mat of any one of the above embodiments wherein the amount of binder utilized on the outer surface of the mounting mat varies from the amount of binder utilized on the inner surface of the mounting mat.

The mounting mat of any one of the above embodiments wherein the amount of binder and the type of binder utilized on the outer surface of the mounting mat varies from the amount of binder and the type of binder utilized on the inner surface of the mounting mat.

The mounting mat of any one of the above embodiments wherein the length of fibers utilized on the outer surface of the mounting mat varies from the length of fibers utilized on the inner surface of the mounting mat.

The mounting mat of any one of the above embodiments wherein the amount of binder and length of fibers utilized on the outer surface of the mounting mat varies from the amount of binder and length of fibers utilized on the inner surface of the mounting mat.

The mounting mat of any one of the above embodiments wherein the type of binder and length of fibers utilized on the outer surface of the mounting mat varies from the type of binder and length of fibers utilized on the inner surface of the mounting mat.

The mounting mat of any one of the above embodiments wherein the amount and type of binder and length of fibers utilized on the outer surface of the mounting mat varies from the amount and type of binder and length of fibers utilized on the inner surface of the mounting mat.

The mounting mat of any one of the above embodiments wherein the inorganic fibers are selected from the group consisting of high alumina polycrystalline fibers, ceramic fibers, mullite fibers, glass fibers, biosoluble fibers, quartz fibers, silica fibers, and combinations thereof.

The mounting mat of any one of the above embodiments wherein the binder comprises at least one sacrificial organic binder, at least inorganic binder or mixtures thereof.

The mounting mat of any one of the above embodiments wherein the binder is an organic binder which comprises at least one of a solid, a liquid, or mixtures thereof.

The mounting mat of any one of the above embodiments wherein the liquid organic binder comprises an aqueous emulsion.

The mounting mat of any one of the above embodiments wherein the aqueous emulsion comprises a dispersion of a polymer within a solvent.

The mounting mat of any one of the above embodiments wherein the aqueous emulsion comprises a latex.

The mounting mat of any one of the above embodiments wherein the latex comprises a thermoplastic resin, a thermosetting resin, or mixtures thereof, which remains flexible after cure.

The mounting mat of any one of the above embodiments wherein the thermosetting resin comprises at least one of unsaturated polyesters, epoxy resins, polyvinyl esters, or mixtures thereof.

The mounting mat of any one of the above embodiments wherein the latex comprises at least one of acrylic latex, (meth)acrylic latex, copolymers of styrene and butadiene, cellulose, a rubber based organic polymer, vinylpyridine, acrylonitrile, copolymers of acrylonitrile and styrene, vinyl chloride, polyurethane, vinyl acetate, copolymers of vinyl acetate and ethylene, polyamides, silicones, butadiene-acrylonitrile lattices, and lattices of acrylate and methacrylate polymers or copolymers, or mixtures thereof.

The mounting mat of any one of the above embodiments wherein the aqueous emulsion comprises an inorganic colloidal material comprising at least one of colloidal silica, colloidal alumina, colloidal zirconia or combinations thereof.

The mounting mat of any one of the above embodiments wherein the solvent comprises at least one of water and acetone.

The mounting mat of any one of the above embodiments wherein the solid or liquid organic binder comprises a solvent-free polymer of at least one of natural rubber, styrene-butadiene rubber, or mixtures thereof.

The mounting mat of any one of the above embodiments wherein the organic binder comprises polymeric binder fibers selected from at least one of polyvinyl alcohol fibers, polyolefin fibers, acrylic fibers, polyester fibers, ethyl vinyl acetate fibers, nylon fibers or mixtures thereof.

The mounting mat of any one of the above embodiments wherein the polyolefin fibers comprise at least one of polyethylene fibers, polypropylene fibers or mixtures thereof.

Also provided is an exhaust gas treatment device comprising: a housing; a fragile structure resiliently mounted within the housing; and a mounting mat disposed in a gap between the housing and the fragile structure, wherein the mounting mat comprises a sheet of inorganic fibers having a first major surface and a second major surface opposite said first major surface, wherein a first portion of said mat has an elongation different from that of a second portion of said mat.

The exhaust gas treatment device of the above embodiment wherein the first major surface has an elongation different from that of the second major surface.

The exhaust gas treatment device of any one of the above embodiments wherein the sheet of inorganic fibers comprises at least one layer of inorganic fibers.

The exhaust gas treatment device of any one of the above embodiments wherein at least two layers of inorganic fibers are heat pressed together to form the sheet of inorganic fibers.

The exhaust gas treatment device of any one of the above embodiments wherein the at least two layers of inorganic fibers have the same or different fiber compositions.

The exhaust gas treatment device of any one of the above embodiments wherein application of a tensile load to the first and second major surfaces stretches the first major surface to a first length and stretches the second major surface to a second length.

The exhaust gas treatment device of any one of the above embodiments wherein the first major surface of the mounting mat is capable of stretching to a length greater than the second major surface of the mounting mat upon application of the same tensile load to the first and second major surfaces without cracking the mounting mat.

The exhaust gas treatment device of any one of the above embodiments wherein said first major surface comprises an inner surface of the mounting mat and wherein said second major surface comprises an outer surface of the mounting mat.

The exhaust gas treatment device of any one of the above embodiments wherein the outer surface of the mounting mat is capable of stretching to a length greater than the inner surface of the mounting mat upon application of the same tensile load to the outer and inner surface without cracking the mounting mat.

The exhaust gas treatment device of any one of the above embodiments wherein the type of binder utilized on the outer surface of the mounting mat varies from the type of binder utilized on the inner surface of the mounting mat.

The exhaust gas treatment device of any one of the above embodiments wherein the amount of binder utilized on the outer surface of the mounting mat varies from the amount of binder utilized on the inner surface of the mounting mat.

The exhaust gas treatment device of any one of the above embodiments wherein the amount of binder and the type of binder utilized on the outer surface of the mounting mat varies from the amount of binder and the type of binder utilized on the inner surface of the mounting mat.

The exhaust gas treatment device of any one of the above embodiments wherein the length of fibers utilized on the outer surface of the mounting mat varies from the length of fibers utilized on the inner surface of the mounting mat.

The exhaust gas treatment device of any one of the above embodiments wherein the amount of binder and length of fibers utilized on the outer surface of the mounting mat varies from the amount of binder and length of fibers utilized on the inner surface of the mounting mat.

The exhaust gas treatment device of any one of the above embodiments wherein the type of binder and length of fibers utilized on the outer surface of the mounting mat varies from the type of binder and length of fibers utilized on the inner surface of the mounting mat.

The exhaust gas treatment device of any one of the above embodiments wherein the amount and type of binder and length of fibers utilized on the outer surface of the mounting mat varies from the amount and type of binder and length of fibers utilized on the inner surface of the mounting mat.

The exhaust gas treatment device of any one of the above embodiments wherein the inorganic fibers are selected from the group consisting of high alumina polycrystalline fibers, ceramic fibers, mullite fibers, glass fibers, biosoluble fibers, quartz fibers, silica fibers, and combinations thereof.

The exhaust gas treatment device of any one of the above embodiments wherein the binder comprises at least one sacrificial organic binder, at least inorganic binder or mixtures thereof.

The exhaust gas treatment device of any one of the above embodiments wherein the binder is an organic binder which comprises at least one of a solid, a liquid, or mixtures thereof.

The exhaust gas treatment device of any one of the above embodiments wherein the liquid organic binder comprises an aqueous emulsion.

The exhaust gas treatment device of any one of the above embodiments wherein the aqueous emulsion comprises a dispersion of a polymer within a solvent.

The exhaust gas treatment device of any one of the above embodiments wherein the aqueous emulsion comprises a latex.

The exhaust gas treatment device of any one of the above embodiments wherein the latex comprises a thermoplastic resin, a thermosetting resin, or mixtures thereof, which remains flexible after cure.

The exhaust gas treatment device of any one of the above embodiments wherein the thermosetting resin comprises at least one of unsaturated polyesters, epoxy resins, polyvinyl esters, or mixtures thereof.

The exhaust gas treatment device of any one of the above embodiments wherein the latex comprises at least one of acrylic latex, (meth)acrylic latex, copolymers of styrene and butadiene, cellulose, a rubber based organic polymer, vinylpyridine, acrylonitrile, copolymers of acrylonitrile and styrene, vinyl chloride, polyurethane, vinyl acetate, copolymers of vinyl acetate and ethylene, polyamides, silicones, butadiene-acrylonitrile lattices, and lattices of acrylate and methacrylate polymers or copolymers, or mixtures thereof.

The exhaust gas treatment device of any one of the above embodiments wherein the aqueous emulsion comprises an inorganic colloidal material comprising at least one of colloidal silica, colloidal alumina, colloidal zirconia or combinations thereof.

The exhaust gas treatment device of any one of the above embodiments wherein the solvent comprises at least one of water and acetone.

The exhaust gas treatment device of any one of the above embodiments wherein the solid or liquid organic binder comprises a solvent-free polymer of at least one of natural rubber, styrene-butadiene rubber, or mixtures thereof.

The exhaust gas treatment device of any one of the above embodiments wherein the organic binder comprises polymeric binder fibers selected from at least one of polyvinyl alcohol fibers, polyolefin fibers, acrylic fibers, polyester fibers, ethyl vinyl acetate fibers, nylon fibers or mixtures thereof.

The exhaust gas treatment device of any one of the above embodiments wherein the polyolefin fibers comprise at least one of polyethylene fibers, polypropylene fibers or mixtures thereof.

Provide is a method of making an exhaust gas treatment device of any one of the above embodiments comprising: providing a mounting mat comprising inorganic fibers comprising a sheet of inorganic fibers having a first major surface and a second major surface opposite said first major surface, wherein a first portion of said mat a first elongation and a second portion of said mat having an elongation different from said first elongation; wrapping the mounting mat around a fragile structure adapted for treating exhaust gases; and disposing the fragile structure having an outer surface and the mounting mat within a housing having an inner surface, whereby the mounting mat holds the fragile structure resiliently within the housing.

While the system has been described in connection with various embodiments, as shown in the various figures, it is to be understood that other similar embodiments may be used or modifications and additions may be made to the described embodiments for performing the same function without deviating therefrom. Furthermore, the various illustrative embodiment may be combined to produce the desired results. Therefore, the variable basis weight support mat system should not be limited to any single embodiment, but rather construed in breadth and scope in accordance with the recitation of the appended claims.

1. A mounting mat for an exhaust gas treatment device comprising a sheet of inorganic fibers having a first major surface and a second major surface opposite said first major surface, wherein the first portion of said mat has an elongation different from that of a second portion of said mat.

2. The mounting mat of claim 1, wherein the first major surface has an elongation different from that of the second major surface.

3. The mounting mat of claim 1, wherein the sheet of inorganic fibers comprises at least one layer of inorganic fibers.

4. The mounting mat of claim 3, wherein at least two layers of inorganic fibers are heat pressed together to form the sheet of inorganic fibers.

5. The mounting mat of claim 4, wherein the at least two layers of inorganic fibers have the same or different fiber compositions.

6. The mounting mat of claim 3, wherein the first major surface of the mounting mat is capable of stretching to a length greater than the second major surface of the mounting mat upon application of the same tensile load to the first and second major surfaces without cracking the mounting mat.

7. The mounting mat of claim 6, wherein said first major surface comprises an inner surface of the mounting mat and wherein the second major surface comprises an outer surface of the mounting mat.

8. The mounting mat of claim 7, wherein the outer surface of the mounting mat is capable of stretching to a length greater than the inner surface of the mounting mat upon application of the same tensile load to the outer and inner surfaces without cracking the mounting mat.

9. The mounting mat of claim 8, wherein the amount and/or type of binder utilized on the outer surface of the mounting mat varies from the type of binder utilized on the inner surface of the mounting mat.

10. The mounting mat of claim 9, wherein the amount of binder, type of binder and/or length of fibers utilized on the outer surface of the mounting mat varies from the amount of binder, type of binder and/or length of fibers utilized on the inner surface of the mounting mat.

11. An exhaust gas treatment device comprising:
a housing;
a fragile structure resiliently mounted within the housing; and
a mounting mat disposed in a gap between the housing and the fragile structure, wherein the mounting mat comprises a sheet of inorganic fibers having a first major surface and a second major surface opposite said first major surface, wherein a first portion of said mat has an elongation different from that of a second portion of said mat.

12. The exhaust gas treatment device of claim 11, wherein the first major surface has an elongation different from that of the second major surface.

13. The exhaust gas treatment device of claim 11, wherein the sheet of inorganic fibers comprises at least one layer of inorganic fibers.

14. The exhaust gas treatment device of claim 11, wherein at least two layers of inorganic fibers are heat pressed together to form the sheet of inorganic fibers.

15. The exhaust gas treatment device of claim 14, wherein the at least two layers of inorganic fibers have the same or different fiber compositions.

16. The exhaust gas treatment device of claim 12, wherein the first major surface of the mounting mat is capable of stretching to a length greater than the second major surface of the mounting mat upon application of the same tensile load to the first and second major surfaces without cracking the mounting mat.

17. The exhaust gas treatment device of claim 16, wherein said first major surface comprises an inner surface of the mounting mat and wherein said second major surface comprises an outer surface of the mounting mat.

18. The exhaust gas treatment device of claim 17, wherein the outer surface of the mounting mat is capable of stretching to a length greater than the inner surface of the mounting mat upon application of the same tensile load to the outer and inner surface without cracking the mounting mat.

19. The mounting mat of claim 18, wherein the amount and/or type of binder utilized on the outer surface of the mounting mat varies from the type of binder utilized on the inner surface of the mounting mat.

20. The mounting mat of claim 18, wherein amount of binder, the type of binder, and/or the length of fibers utilized on the outer surface of the mounting mat varies from the length of fibers utilized on the inner surface of the mounting mat.
